(19) United States
(12) Patent Application Publication
(10) Pub. No.: US 2011/0292760 A1
(43) Pub. Date: Dec. 1, 2011

(54) SEISMIC EQUIPMENT HANDLING

(75) Inventor: Robert W. Hayes, Maurice, LA (US)

(73) Assignee: BERZERKER, INC., Lake Arthur, LA (US)

(21) Appl. No.: 13/205,838

(22) Filed: Aug. 9, 2011

Related U.S. Application Data
(63) Continuation-in-part of application No. 12/708,577, filed on Feb. 19, 2010.

(51) Int. Cl. G01V 1/38

(52) U.S. Cl. 367/20

(57) ABSTRACT

Launch and retrieval equipment for use in seismic testing and methods for seismic testing are described. Elements of the equipment may include a pivoting frame to hold the seismic equipment, sliding rails that hold the seismic equipment in place on the frame and a winch and line that operates to launch the seismic equipment keeping it tethered to a vessel. The launch device is capable of launching and retrieving seismic equipment without the use of conventional cranes.

This application claims the benefit of non-provisional application Ser. No. 12/708,577 filed on Feb. 19, 2010 entitled “Seismic Equipment Handling.”

Deploying and retrieving seismic equipment to and from marine vessels for seismic testing by conventional overhead lifting presents significant risks to both equipment and personnel. Much of this risk is associated with the use of cranes in deployment and retrieval. Developments in seismic testing procedures and equipment have failed to adequately address these concerns.

Disclosed herein are embodiments of the present invention that address the needs described above by providing devices and methods that provide safe and efficient seismic testing. An apparatus having features of the present invention includes a device for the launching, testing, and retrieving of seismic equipment which is referred to in various descriptions of the invention as a “launch device” for the sake of brevity.

An apparatus for seismic testing having features of the present invention includes a seismic device capable of an action selected from producing, recording, and transmitting seismic activity; a marine vessel; a support structure; at least one movable brace capable of securing the seismic device in a fixed position relative to the support structure; and a line tethering the support structure to the seismic device. In that apparatus, the support structure is attached to the marine vessel, the support structure supports the weight of the seismic device, the support structure is actuated for movement relative to the marine vessel, and the seismic device is capable of being launched into water surrounding the marine vessel by providing slack to the line. In separate but related embodiments of the invention, the line is attached to a winch at the support structure, the winch is capable of providing enough line to allow tethered operation of the seismic device at a position significantly removed from the marine vessel and capable of returning the seismic device to the marine vessel, the seismic device is a submersible seismic device, the support structure is attached to the marine vessel at a pivot, the support structure is capable of rotating about the pivot with respect to the marine vessel, and there are two movable braces.

A method of performing seismic testing from a marine vessel having features of the present invention includes: loading a seismic device onto a base of a support structure wherein the seismic device is capable of an action selected from producing, recording, and transmitting seismic activity and wherein the support structure comprises at least one immobilizing device capable of securing the seismic device in a first fixed position relative to the support structure, which comprises an actuator capable of moving the support structure relative to the marine vessel; tethering the seismic device to the support structure with a line; operating the at least one immobilizing device to secure the seismic device in a second fixed position relative to the base; operating the actuator to move the center of gravity of the seismic device away from the center of gravity of the marine vessel, operating the at least one immobilizing device to release the seismic device from the second fixed position relative to the base; and lowering the seismic device into water by either releasing the tether or providing slack to the tether. In separate but related embodiments of the invention, the at least one immobilizing device is at least one movable brace, the at least one immobilizing device is at least two moveable braces that press against the seismic device in opposite directions, the line is fed from a winch and the winch is capable of providing enough line to the tether to allow operation of the seismic device at a position significantly removed from the marine vessel, the winch is operated to return the seismic device to the support structure, the operating of the actuator to move the center of gravity of the seismic device away from the center of gravity of the marine vessel causes the center of gravity of the seismic device to move from over the marine vessel to over the water, the tethering of the seismic device to the support structure acts to deter the movement of the seismic device relative to the support structure, the seismic device is a submersible seismic device with a buoy, the operation of the actuator to move the center of gravity of the seismic device away from the center of gravity of the marine vessel causes the support structure to rotate on a hinge, and the actuator contains a hydraulic piston.

A further method of performing seismic testing from a marine vessel having features of the present invention includes steps described above and additional steps including allowing the seismic device to separate from the marine vessel and arrive at a testing location; operating the seismic device to cause an action selected from producing, recording, and transmitting seismic activity;

operating a winch to reel in the line and draw the seismic device onto the base of the support structure; operating the at least one immobilizing device to secure the seismic device in a third fixed position relative to the base; and operating the actuator to move center of gravity of the seismic device toward the center of gravity of the marine vessel. In a still further method of performing seismic testing from a marine vessel, the first fixed position, the second fixed position, and the third fixed position are substantially the same position.

The methods described herein may, for example, comprise holding a seismic device in a first position over the deck of a vessel with a first operating influence; moving the seismic device over a threshold of the vessel while continuing to hold the seismic device with the first operating influence; actuating a second operating influence such that the seismic device is lowered from the vessel to the water; drawing the seismic device to a testing position with a third operating influence; performing a seismic test with the seismic device; drawing the seismic device back to the vessel with the second operating influence; actuating the second operating influence thereby moving the seismic device into a position suitable for engagement with the first operating influence; engaging the first operating influence so as to hold the seismic device; and moving the seismic device over the threshold of the vessel to a second position over the deck of the vessel. In a related method, the seismic device is flexibly connected to both the second operating influence and the first operating influence. In a further related method, the third operating influence is arranged and configured to pull the seismic device through the water based on instructions received from the vessel.

The methods described herein may, for example, comprise securing a seismic device in a first position within the ordinary perimeter of a vessel with a first securing device such that the seismic device is restrained from substantial movement relative to the vessel; moving the seismic device to a launching position outside of the ordinary perimeter of the vessel such that the seismic device is restrained against movement imparted by forces other than the first securing device; and deploying the seismic device into water. A related method may further comprise utilizing the seismic device to conduct seismic testing at a testing location; drawing the seismic device to the vessel with a tether; securing the seismic device with the first securing device; and moving the seismic device to a position within the ordinary perimeter of the vessel. In a related method, the seismic device is tethered to the first securing device by a tether. In a further related method, the seismic device is connected to a buoy. In a still further related method, the first securing device is slidably attached to the vessel. In a further related method the step of drawing the seismic device to a testing position with a third operating influence comprises towing the seismic device to a testing location with an unmanned remotely operated vehicle; the first securing device comprises a first load actuator configured to impart translational motion relative to the vessel; and the first securing device comprises a second load actuator configured to impart rotational motion relative to the vessel. Load actuators may, for example, take the form of a hydraulic piston. In a further related method, the first securing device further comprises a platform connected to a platform support by a hinge; the platform support is configured for guided movement relative to the vessel by rail; and the first operating influence is substantially within the ordinary perimeter of the vessel when the seismic device is in the first position. In another related method, the seismic device is frictionally held within the first operating influence when the seismic device is in the first position.

An apparatus having features of the present invention may for example comprise a seismic device; a marine vessel having a deck; a vessel mounting support connected to the marine vessel; a support structure; wherein the support structure is movably attached to the vessel mounting support; wherein the support structure is actuated for movement relative to the marine vessel; wherein the seismic device is secured on the support structure by a tether; wherein the seismic device is releaseably secured on the support structure by frictional contact; and wherein the support structure is arranged and configured to travel between a first position substantially above the deck and a launching position in which the support structure is substantially outside of the space above the deck; In a related embodiment, the support structure is arranged and configured to launch the seismic device into water for tethered operation of the seismic device. In a further related embodiment, the support structure's movable attachment to the vessel mounting support comprises one or more rails. In a still further related embodiment, the support structure's movable attachment to the vessel mounting support comprises at least one hinge. In a further related embodiment, the at least one hinge supports a majority of the weight of the support structure. In a related embodiment, a remotely operated vehicle may be tethered to the seismic device. In a related embodiment, the remotely operated vehicle may be configured to transmit its GPS position to the vessel. In a related embodiment, the support structure may further comprise a winch. In a related embodiment, the seismic device may be tethered to a buoy.

### BRIEF DESCRIPTION OF THE DRAWINGS

FIG. 1 shows a side view of an embodiment of the launch device in the pre-launch position.

FIG. 2 shows a side view of an embodiment of the launch device in the process of launching seismic equipment.

FIG. 3 shows a side view of an embodiment of the launch device tethered to seismic equipment that has been launched.

FIG. 4 shows a top view of an embodiment of the launch device.

FIG. 5 shows a perspective view of an embodiment of the launch device.

FIG. 6 shows a side view of an embodiment of the launch device in the pre-launch position.

FIG. 7 shows a side view of an embodiment of the launch device in the process of launching seismic equipment.

FIG. 8 shows a side view of an embodiment of the launch device tethered to seismic equipment that has been launched.

FIG. 9 shows a close up side view of an embodiment in which internal components of a portion of the trolley system are shown.

FIG. 10 shows a portion of the trolley system looking down the long axis the trolley rail.

FIG. 11 shows a detailed view of the remote towing device.

### DETAILED DESCRIPTION

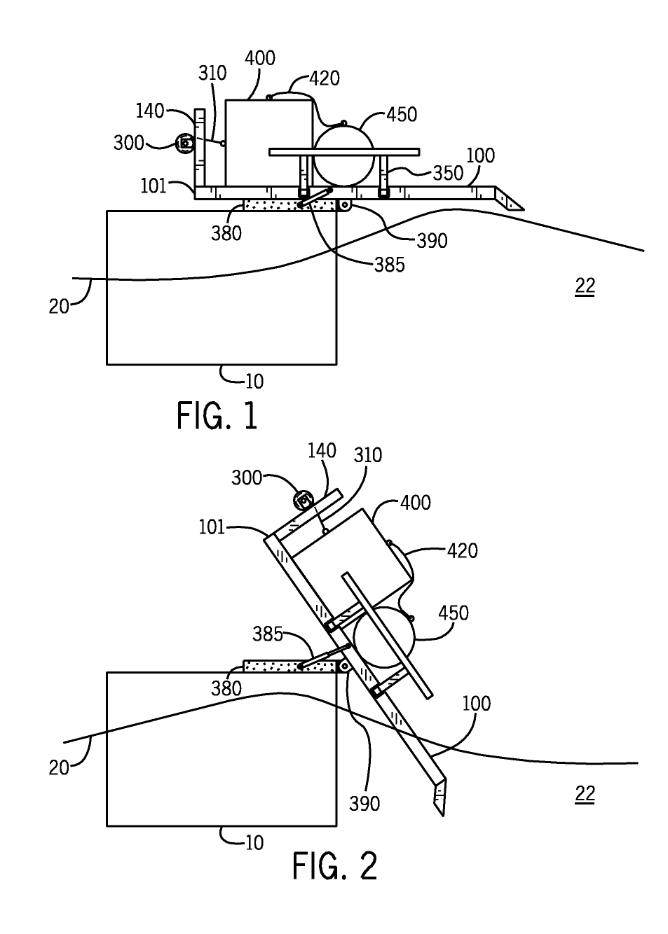

Now referring to FIG. 1 of the drawings, a launch device is mounted to a vessel 10 at a position accessible to the water 22 indicated by water line 20. The launch device is positioned with respect to the edge of vessel 10 such that a significant portion of frame base 100 extends over the water 22 and the remainder of frame base 100 is above vessel 10. Vessel 10 may be any variety of nautical or marine vessels including boats, ships, barges, and oil and gas platforms. Frame base 100 is connected to frame base support 380 by hinge 390 which restrains the movement of frame base 100 to pivoting about frame base 100. Frame base 100 may be also be characterized as a support structure having a base 101 and a rear frame 140 Hydraulic lift 385 actuates the movement of frame base 100 about hinge 390. Hydraulic lift 385 may take the form of a hydraulic piston. When frame base 100 is in a position parallel to frame base support 380, frame base 100 may be secured to frame base support 380 by a locking pin (not shown). FIG. 1 shows frame base 100 parallel to frame base support 380. This position is the “pre-launch position” for the launch device.

Seismic device 400, buoy 450, and buoy cable 420 rest on frame base 100. Significant movement of seismic device 400 in the direction of or away from rear frame 140 is restrained by cable 310 and rear frame 140. Significant side to side movement of seismic device 400 and buoy 450 is restrained by side rail 350 which may take the form of a moveable brace or a sliding rail and may further be characterized as an immobilizing device. Side rail 350 preferably contacts seismic device 400 at a height that is roughly equivalent to the height of the center of gravity of seismic device 400 when seismic device 400 is resting on the base 101 of frame base 100. Slack may be provided or taken from cable 310 by the operation of winch 300.

FIG. 2 of the drawings shows a side view of the launch device in a launching position. The term “launching position” refers to the fact that frame base 100 is in an inclined position with respect to frame base support 380. The launching position is attained by actuation of hydraulic lift 385.

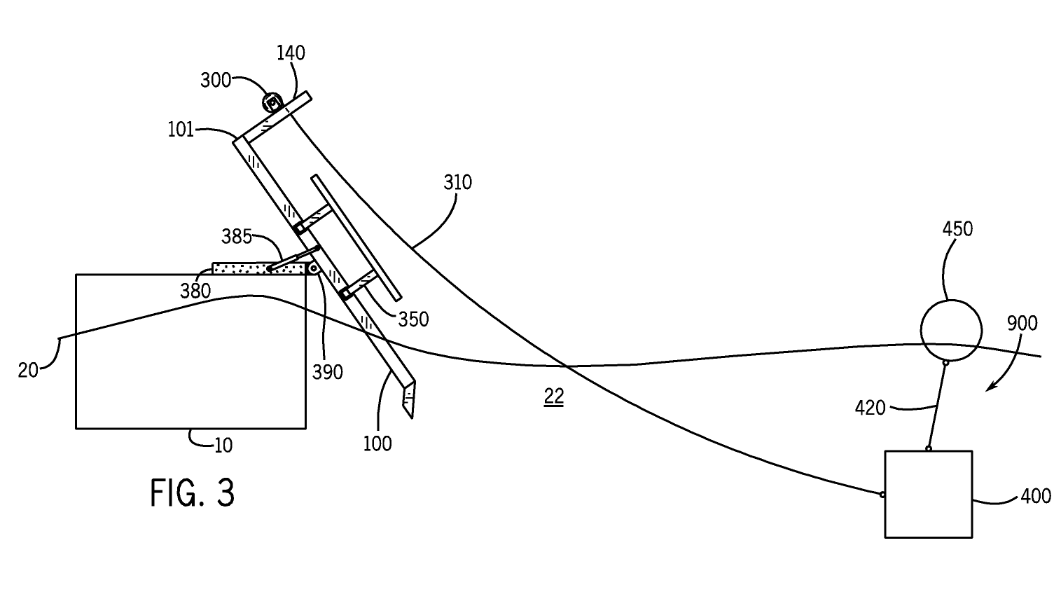

FIG. 3 of the drawings shows a side view of the launch device in which seismic device 400 has been launched and is floating with the assistance of buoy 450 and buoy cable 420. Cable 310 tethers seismic device 400 to winch 300 and the launch device allowing seismic device 400 to float at testing location 900. Testing location 900 may be at a location that is significantly removed from the marine vessel.

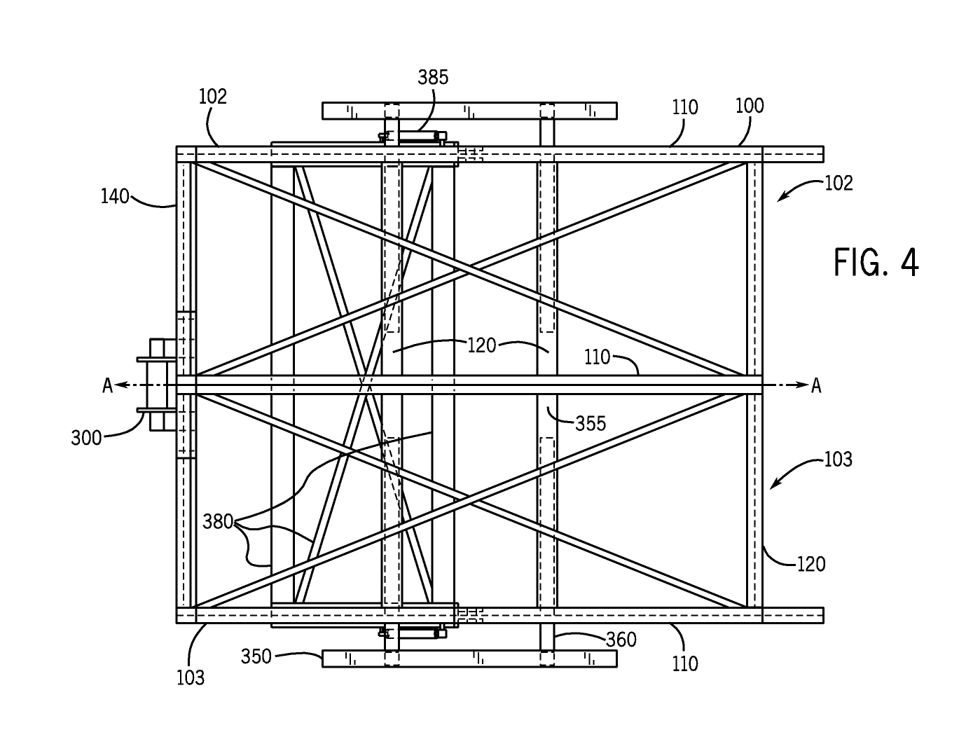

FIG. 4 of the drawings shows a top view of the launch device. Frame base 100 is made up of a base 101 and a rear frame 140. Base 101 of frame base 100 may be divided along the axis A in such a way that base 101 contains two sections that substantially mirror each other about axis A and are joined at axis A. Those sections are labeled in FIG. 4 as first base section 102 and second base section 103. Both first base section 102 and second base section 103 contain multiple frame base width span members 120 and multiple frame base lengthwise members 110. The frame base width span members 120 and frame base lengthwise members 110 are fastened to one another. First base section 102 and second base section 103 are removably fastened to one another. Winch 300 is supported by rear frame 140 which attaches to base 101 of frame base 100. Frame base support 380 supports frame base 100 in the manner described above. Side rails 350 are attached to slide rail support tube 360 which is slidably situated within slide rail guide tube 355. Slide rail 350 slides toward and away from the space above frame base 100 in such a way that it is able to restrain the movement of seismic device 400 and release seismic device 400 as needed. Slide rail 350 may be actuated hydraulically or by other means and may be secured by a locking pin or equivalent securing means.

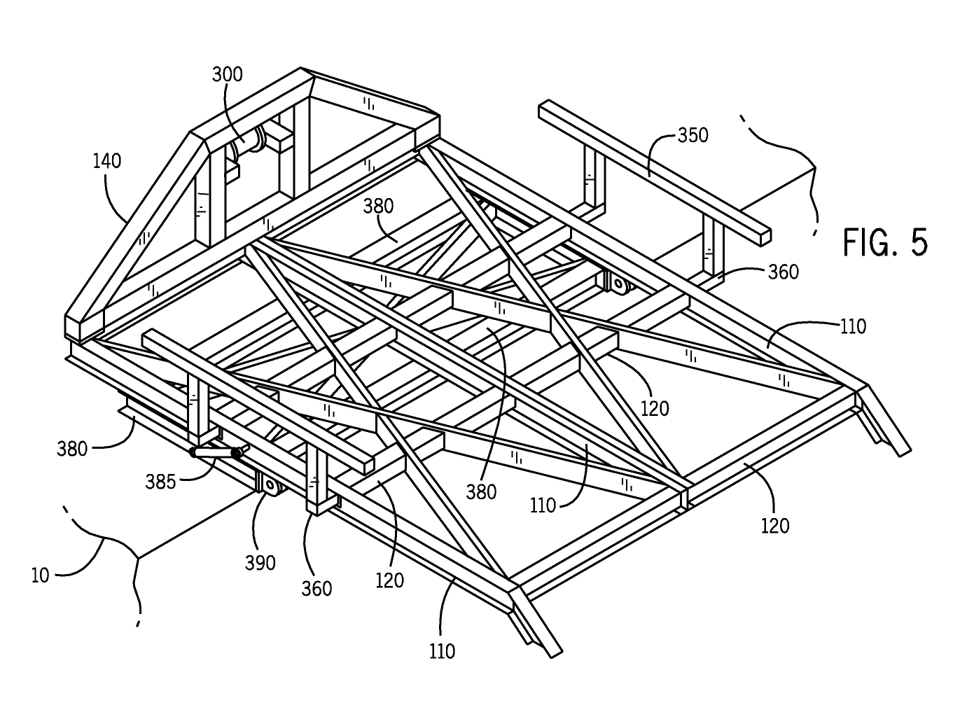

FIG. 5 is a perspective view of the launch device. Each of the elements shown in FIG. 5 is described above.

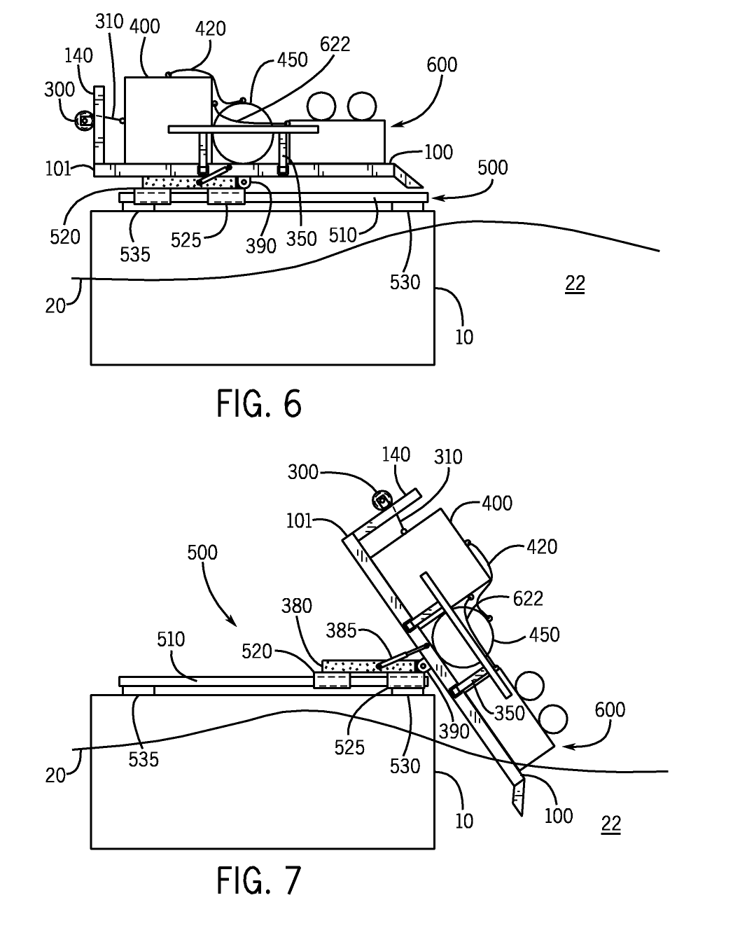

Now referring to FIG. 6 of the drawings, Vessel 10 is situated in Water 22 with Water line 20 being on the vessel. Trolley system 500 is situated on Vessel 10 such that Foreword trolley rail support 530 and Rear trolley rail support 535 connect First trolley rail 510 to the Vessel 10. Forward trolley 525 and Rear trolley 520 are slideably attached to First trolley rail 510 such that Frame base 100 is capable of movement along First trolley rail 510 and relative to Vessel 10. The movement of Frame base 100 is further such that Frame base 100 moves toward and away from a position that is adjacent to the Vessel 10 that is outside the boundaries of Vessel 10. Forward trolley 525 and Rear trolley 520 are attached to Frame base support 380 (speckled shading, numbered in FIG. 7). Frame base support 380 is connected to Base 101 of Frame base 100 by way of Hinge 390. Frame base 100 pivots around Hinge 390. Frame base 100 is made up of Base 101 and Rear frame 140. Winch 300 is attached to Rear frame 140 and Winch 300 tethers Seismic device 400 to Rear frame 140 by way of Cable 310. Each of Remote towing device 600, Buoy 450, and Seismic device 400 rest on Base 101 of Frame base 100. Remote towing device 600 is attached to Seismic device 400 by way of Tow line 622. Buoy cable 420 connects Buoy 450 to Seismic device 400.

FIG. 7 of the drawings represents the embodiment depicted in FIG. 6 of the drawings after Frame base 100 has been actuated to impart translational movement in the direction of the edge of Vessel 10 and rotational movement about Hinge 390. Drawing elements not separately recited are the same as shown in FIG. 6. Rear trolley 520 and Forward trolley 525 have moved along First trolley rail 510 such that Frame base support 380 is positioned near the edge of Vessel 10. Frame base 100 and the pieces of equipment originally situated on top of Frame base 100 have rotated about Hinge 390 such that the equipment is transitioning from being horizontally oriented with respect to one another to being vertically oriented with respect to one another. Hydraulic lift 385 provides the motive force to rotate Frame base 100 with respect to Frame base support 380.

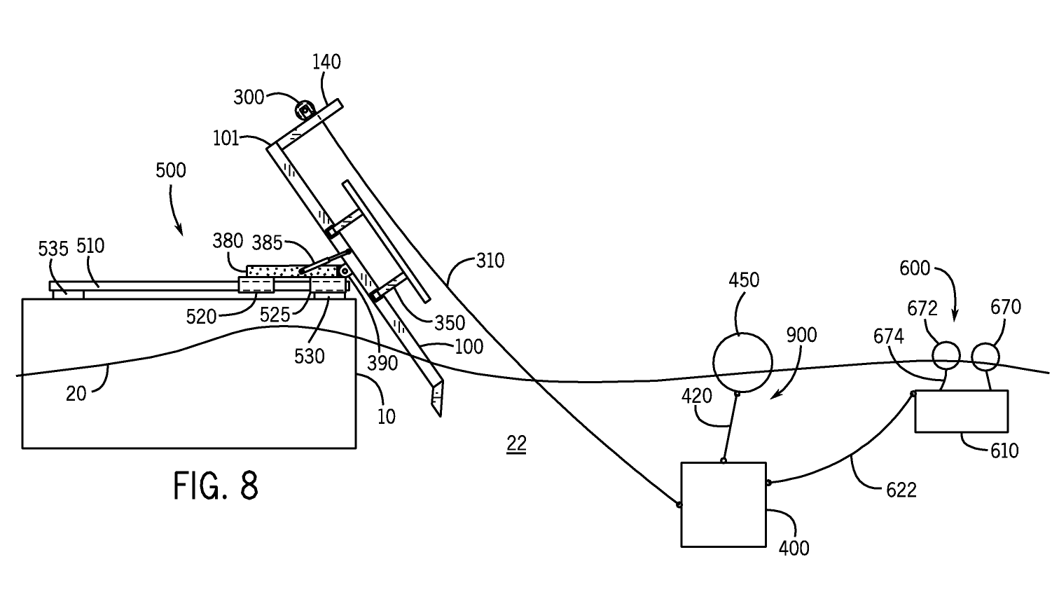

FIG. 8 of the drawings represents the embodiment depicted in FIG. 6 of the drawings and FIG. 7 of the drawings in which Seismic device 400 is deployed in Water 22. FIG. 8 is illustrative in part due to the fact that Testing location 900 would not typically be as close to Vessel 10 as represented in the drawing. Cable 310 would typically be many times the depicted length due to the fact that Testing location 900 would typically be a significant distance from Vessel 10. Drawing elements not separately recited are the same as shown in FIG. 6. Base 101 is shown in FIG. 8 as having a significant incline and depending on the placement of items such as First trolley rail 510 and Foreword trolley rail support 530 with respect to Vessel 10 Base 101 may take on a vertical orientation. Winch 300 allows for slack in Cable 310 allowing the tethered deployment of Seismic device 400 away from Vessel 10 with Tow line 622 connecting Remote towing device 600 to Seismic device 400. Remote towing device 600 is held at a relatively constant depth in Water 22 by First tow device buoy 670 and Second tow device buoy 672. First tow device buoy 670 and Second tow device buoy 672 are tethered to Towing device frame 610 of Remote towing device 600 by Tow device buoy lines 674. Seismic device 400 maintains a position at a depth that is determined by the length of Buoy cable 420 which is attached to Buoy 450. The sliding motion of Frame base support 380 with respect to Vessel 10, the rotational motion of Frame base 100 with respect to Frame base support 380, and the operation of Side rail 350 are each described above.

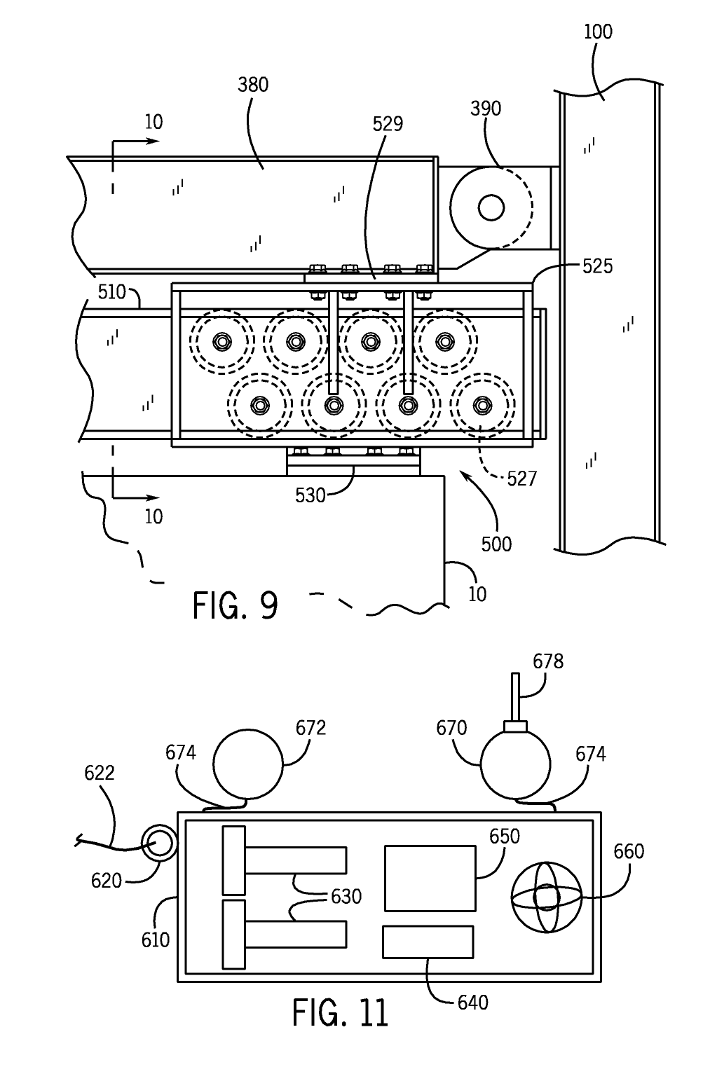

FIG. 9 represents a close up side view of an embodiment in which internal components of a portion of Trolley system 500 are shown. In the present embodiment, Base 101 represented in the drawing as Frame base 100 is vertically oriented. Frame base 100 is connected to Frame base support 380 by way of Hinge 390. Frame base support 380 is attached by bolts, welding or other suitable means to Forward trolley 525. The connection of Forward trolley 525 to Frame base support 380 may be made by Trolley base 529. Forward trolley 525 surrounds First trolley rail 510 and is slideably connected thereto by Trolley wheels 527. First trolley rail 510 is connected to Vessel 10. Vessel 10 and First trolley rail 510 are optionally connected by way of a metal plate such as Foreword trolley rail support 530.

Referring now to FIG. 11 of the drawings, Remote towing device 600 is made up of several components. Remote towing device 600 may be connected to Seismic device 400 by way of Tow point 620 and Tow line 622. Tow point 620 is attached to Towing device frame 610 which may optionally serve as the primary support structure of Remote towing device 600. Forward thrusters 630 impart the primary thrust for the operation of Remote towing device 600 and are attached either directly or indirectly to Towing device frame 610. Control unit 640 may house microprocessors, distributed control systems, and/or other equipment capable of instructing the operation of the components of Remote towing device 600. Hydraulic power unit 650 is optionally used to provide hydraulic power to the various components of Remote towing device 600. Steering thruster 660 is used to control the direction of Remote towing device 600 by causing a yaw analogous to the flight control of an airplane. First tow device buoy 670 and Second tow device buoy 672 hold Remote towing device 600 at a substantially uniform depth by way of Tow device buoy lines 674. In an alternate embodiment, Remote towing device 600 could be a floating device. GPS antenna 678 is used to track the location of Remote towing device 600 and in particular to gauge the location of Remote towing device 600 with respect to Testing location 900. GPS antenna 678 may be located atop a buoy such as First tow device buoy 670 or in another location suitable to allow the direction of Remote towing device 600 to Testing location 900.

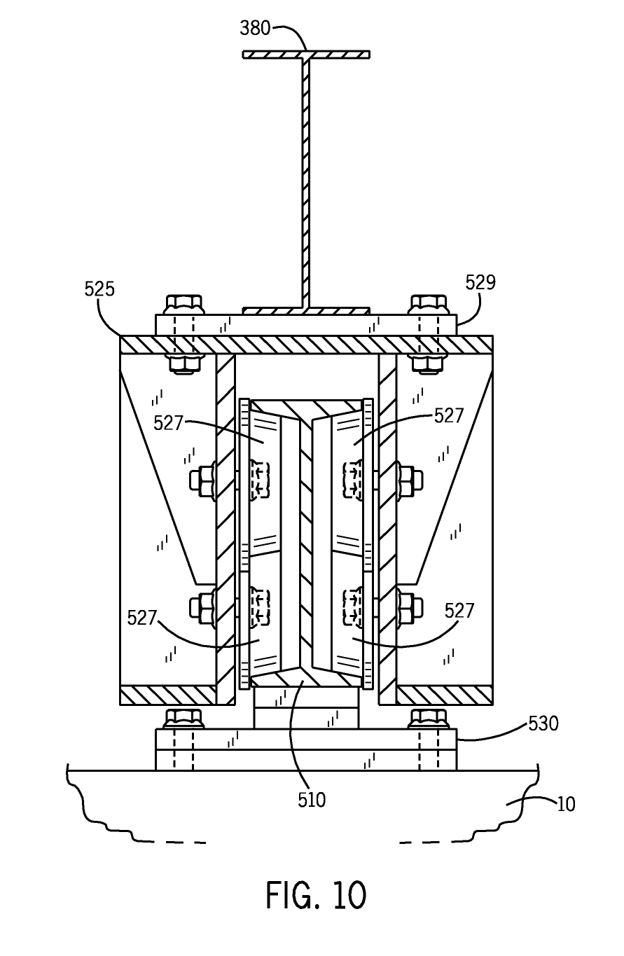

FIG. 10 of the drawings depicts a portion of Trolley system 500 looking down the long axis of First trolley rail 510. Foreword trolley rail support 530 sits atop and is connected to Vessel 10. Trolley wheels 527 roll along First trolley rail 510 such that Trolley wheels 527 occupy a substantial portion of the space within First trolley rail 510. Trolley wheels 527 are attached to Forward trolley 525 such that Forward trolley 525 is able to slide along First trolley rail 510. Trolley base connection 529 is connected to both Frame base support 380 and Forward trolley 525 creating a secure connection between the two.

Operation of the launch device may be accomplished by first loading seismic device 400 and buoy 450 onto frame base 100. Second, slide rails 350 are slid against the seismic device 400. With cable 310 attached and taut, hydraulic lift 385 is then actuated such that frame base 100 pivots about hinge 390 in a way that raises rear frame 140 with respect to vessel 10. The actuation of hydraulic lift 385 is stopped when frame base 100 is in or near the water 22. This position is the launching position. Upon reaching the launching position, slide rails 350 are withdrawn from contact with seismic device 400. Winch 300 is actuated to provide slack to cable 310 allowing seismic device 400 and buoy 450 to enter the water 22 and ultimately drift away from vessel 10. Seismic device 400 may then be operated when in the correct position for a seismic test. The details of operation of the seismic device are according to known procedures or according to procedures appropriate to the specific equipment being used. Retrieval of seismic device 400 is accomplished by reversing the process. First, winch 300 reels seismic device 400 and buoy 450 onto frame base 100. Then, side rails 350 are pressed against seismic device 400 securing it in place. Finally, hydraulic lift 385 is actuated to bring frame base 100 into the pre-launch position, parallel with frame base support 380. Because this operation does not use a crane, many safety concerns associated with the launching of seismic device 400 are avoided.

Operation of the embodiment depicted in FIG. 8 of the drawings is comparable to the operation described above, but may involve the following additional procedures. The Launch device may begin in a position in which Frame base 100 is situated such that Rear trolley 520 is at or near the end of First trolley rail 510 that is not adjacent to the edge of Vessel 10. Prior to deployment of Seismic device 400, Frame base support 380, Forward trolley 525, and Rear trolley 520 slide toward the edge of Vessel 10. Rotation about Hinge 390 and the deployment of Seismic device 400 into Water 22 takes place in a manner comparable to the procedures described above. However, Remote towing device 600 tows Seismic device 400 to Testing location 900. Once testing is complete Winch 300 draws Seismic device 400 and Remote towing device 600 back to Vessel 10 so that they can be loaded onto Frame base 100 in a manner comparable to that described above. Once Frame base 100 has been made level with Frame base support 380, Frame base support 380 is returned to its initial position.

The launch device may be broken up into its individual components to facilitate shipping to and from the vessel. The launch device may be broken up into individual components including first base section 102, second base section 103, and rear frame 140. These individual sections and the other components of the device are sized and configured for easy shipping including shipping over the highway with a tractor-trailer. Each of the pieces of the launch device are less than 8 feet 6 inches in either length, width, or height. These shipping characteristics allow for shipment to and from the vessel as component parts with assembly and disassembly occurring on the vessel.

The Launch device may be characterized broadly by the operating influences that govern the position and movement of Seismic device 400 and the related equipment. For example, equipment involved in securing Seismic device 400 may be broadly characterized as a first operating influence. The first operating influence may for example take the form of frictional contact with Frame base 100 or Side rails 350. Equipment involved in the positioning of Seismic device 400 may be characterized as a second operating influence. The second operating influence may for example take the form of Cable 310. Equipment involved in the guiding of Seismic device 400 to Testing location 900 may be characterized as a third operating influence. The third operating influence may for example take the form of Remote towing device 600.

Depictions and descriptions of embodiments are in part based on the two-dimensional representations of those embodiments and various aspects of embodiments described herein are omitted because the explanation would be redundant. For example, the components described as making up Trolley system 500 are substantially replicated on the side opposite the side of Launch device shown in FIG. 8.

The term “vessel” as used herein is used to broadly denote any mobile or non-mobile apparatus capable of operation in the open water and capable of carrying seismic equipment. Examples of apparatus that may be characterized as a vessels include boats, ships, and oil and gas platforms including drilling platforms.

Any and all reference to patents, documents and other writings contained herein shall not be construed as an admission as to their status with respect to being or not being prior art. It is understood that the array of features and embodiments taught herein may be combined and rearranged in a large number of additional combinations not directly disclosed, as will be apparent to one having skill in the art and that various embodiments of the invention may have less than all of the benefits and advantages disclosed herein.

There are, of course, other alternate embodiments which are obvious from the foregoing descriptions of the invention, which are intended to be included within the scope of the invention, as defined by the following claims.

I claim:

1. A method of conducting seismic testing comprising:
(a) holding a seismic device in a first position over the deck of a vessel with a first operating influence;
(b) moving the seismic device over a threshold of the vessel while continuing to hold the seismic device with the first operating influence;
(c) actuating a second operating influence such that the seismic device is lowered from the vessel to the water;
(d) drawing the seismic device to a testing position with a third operating influence;
(e) performing a seismic test with the seismic device;
(f) drawing the seismic device back to the vessel with the second operating influence;
(g) actuating the second operating influence thereby moving the seismic device into a position suitable for engagement with the first operating influence;
(h) engaging the first operating influence so as to hold the seismic device; and
(i) moving the seismic device over the threshold of the vessel to a second position over the deck of the vessel.

2. The method of claim 1 wherein the seismic device is flexibly connected to both the second operating influence and the third operating influence.

3. The method of claim 2
(a) wherein the step of drawing the seismic device to a testing position with a third operating influence comprises towing the seismic device to a testing location with an unmanned remotely operated vehicle;
(b) wherein the first operating influence comprises a first load actuator configured to impart translational motion relative to the vessel; and
(c) wherein the first operating influence comprises a second load actuator configured to impart rotational motion relative to the vessel.

4. The method of claim 1 wherein the third operating influence is arranged and configured to pull the seismic device through the water based on instructions received from the vessel.

5. The method of claim 4
(a) wherein the first operating influence further comprises a platform connected to a platform support by a hinge;
(b) wherein the platform support is configured for guided movement relative to the vessel by rail; and
(c) wherein the first operating influence is substantially within the ordinary perimeter of the vessel when the seismic device is in the first position.

6. A method of conducting seismic testing comprising:
(a) securing a seismic device in a first position within the ordinary perimeter of a vessel with a first securing device such that the seismic device is restrained from substantial movement relative to the vessel;
(b) moving the seismic device to a launching position substantially outside of the ordinary perimeter of the vessel such that the seismic device is restrained against movement imparted by forces other than the first securing device; and
(c) deploying the seismic device into water.

7. The method of claim 6 further comprising:
(a) utilizing the seismic device to conduct seismic testing at a testing location;
(b) drawing the seismic device to the vessel with a tether;
(c) securing the seismic device with the first securing device; and
(d) moving the seismic device to a position within the ordinary perimeter of the vessel.

8. The method of claim 6 wherein the seismic device is tethered to the first securing device by a tether.

9. The method of claim 6 wherein the seismic device is connected to a buoy.

10. The method of claim 6 wherein the first securing device is slidably attached to the vessel.

11. The method of claim 6 wherein the seismic device is frictionally held within the first securing device when the seismic device is in the first position.

12. An apparatus for seismic testing comprising:
(a) a seismic device;
(b) a marine vessel having a deck;
(c) a vessel mounting support connected to the marine vessel;
(d) a support structure;
(e) wherein the support structure is movably attached to the vessel mounting support;
(f) wherein the support structure is actuated for movement relative to the marine vessel;
(g) wherein the seismic device is secured on the support structure by a tether;
(h) wherein the seismic device is releaseably secured on the support structure by frictional contact; and
(i) wherein the support structure is arranged and configured to travel between a first position substantially above the deck and a launching position in which the support structure is substantially outside of the space above the deck;

13. The apparatus of claim 12 wherein the support structure is arranged and configured to launch the seismic device into water for tethered operation of the seismic device.

14. The apparatus of claim 12 wherein the support structure's movable attachment to the vessel mounting support comprises one or more rails.

15. The apparatus of claim 12 wherein the support structure's movable attachment to the vessel mounting support comprises at least one hinge.

16. The apparatus of claim 15 wherein the at least one hinge supports a majority of the weight of the support structure.

17. The apparatus of claim 12 further comprising a remotely operated vehicle tethered to the seismic device.

18. The apparatus of claim 17 wherein the remotely operated vehicle is configured to transmit its GPS position to the vessel.

19. The apparatus of claim 12 wherein the support structure further comprises a winch.

20. The apparatus of claim 12 wherein the seismic device is tethered to a buoy.
